(19) United States
(12) Patent Application Publication
(10) Pub. No.: US 2004/0215491 A1
(43) Pub. Date: Oct. 28, 2004

(54) Providing comprehensive online health-related information and services

(76) Inventors: Paul T. Clark, Wellesley, MA (US); Margaret A. Moore, West Vancouver (CA)

Correspondence Address: CLARK & ELBING LLP, 101 FEDERAL STREET, BOSTON, MA, 02110, US

(21) Appl. No.: 10/848,664

(22) Filed: May 19, 2004

Related U.S. Application Data
(63) Continuation of application No. 09/657,748, filed on Sep. 8, 2000, now abandoned.
Application No. 09/657,748 is a continuation-in-part of application No. 09/628,607, filed on Jul. 31, 2000.
Application No. 09/628,607 is a continuation-in-part of application No. 09/415,622, filed on Oct. 12, 1999, now abandoned.
Application No. 09/415,622 is a continuation-in-part of application No. 09/379,448, filed on Aug. 23, 1999, now abandoned.

(51) Int. Cl. G06F 17/60

(52) U.S. Cl. 705/2

(57) ABSTRACT

The method for providing health-related information and services to multiple people online, said method comprising the steps of: a) providing, to consumers who request it, online, real-time, personalized, fee-based coaching on health or fitness-related issues specifically of concern to each of said consumers; and b) performing one or more additional steps selected from the group consisting of: i) periodically providing, to a plurality of consumers, online, health or fitness-related information specifically pertinent to a health or fitness issue of each said consumer or a relative of said consumer; ii) providing, to a plurality of healthcare or fitness professionals, online, access to non-personalized information relating to health or fitness-related issues; iii) providing, to a plurality of healthcare or fitness professionals, access to information specifically pertinent to a specialty of each of said healthcare or fitness professionals; iv) providing, to consumers who request it, referrals to experts for consultation on a health or fitness-related issue of specific concern to each of said consumers; v) providing, to consumers who request them, online, personalized plans for addressing health or fitness-related issues of specific concern to each of said consumers; vi) providing, to consumers who request it, access to experts for consultation on health or fitness-related issues of specific concern to each of said consumers; vii) providing, to a plurality of consumers, online access to non-personalized information pertaining to health and fitness-related issues; and viii) providing, to multiple consumers and/or health or fitness professionals, the option to accept opt-in advertising.

### CROSS-REFERENCE TO RELATED APPLICATIONS

This application is a continuation of U.S. Ser. No. 09/657,748, filed Sep. 8, 2000, which is a continuation-in-part of U.S. Ser. No. 09/628,607, filed Jul. 31, 2000, which is a continuation-in-part of U.S. Ser. No. 09/415,622, filed Oct. 12, 1999, which is a continuation-in-part of U.S. Ser. No. 09/379,448, filed Aug. 23, 1999, each of which is hereby incorporated by reference.

### BACKGROUND OF THE INVENTION

The Web today plays a large role in providing health-related information, products, and services to millions of consumers. Despite this large role, the eHealth/Fitness sector has performed poorly in terms of profits and return on investment, because many business models are unsound, and because those with promise have been diluted by too many entrants. A prominent example of a model that may be fundamentally flawed is the combination of free eHealth/Fitness content with online advertising. The enormous demand for health and fitness-related help on the Web can, in the long term, only be met through a comprehensive revenue and profit-generating business model.

### SUMMARY OF THE INVENTION

The invention provides a comprehensive system for providing online information and services to consumers, and healthcare and fitness professionals (including physicians, nurses, physical therapists, dietitians, chiropractors, and certified fitness professionals) in an efficient, user-friendly manner, and also provides a business model that is economically viable, i.e., one that provides value to consumers, and profits and return on investment for stockholders.

Accordingly, the invention provides a method for providing health and fitness-related information and services to a plurality of people online, by: a) providing, to consumers who request it, online, real-time, fee-based personalized coaching on health and fitness-related issues specifically of concern to each of the consumers, and b) performing one or more additional steps selected from the group consisting of: i) periodically providing, to a plurality of consumers, online, health and fitness-related information specifically pertinent to a health and fitness issue of each consumer or a relative of the consumer; ii) providing, to a plurality of physicians, online, access to non-personalized information relating to health or fitness-related issues; iii) providing, to a plurality of physicians, access to information specifically pertinent to a specialty and interests of each of the physicians; iv) providing, to consumers who request it, referrals to experts for consultation on a health or fitness-related issue of specific concern to each of the consumers; v) providing, to consumers who request them, online, personalized plans for addressing health or fitness-related issues of specific concern to each of the consumers; vi) providing, to consumers who request it, access to experts for consultation on health or fitness-related issues of specific concern to each consumer; vii) providing to a plurality of consumers online access to non-personalized information pertaining to health or fitness-related issues; and viii) providing, to a plurality of online consumers and health and fitness professionals, the option to accept opt-in online advertising.

In preferred embodiments, the method includes 2, 3, 4, 5, 6, 7, or all of the additional steps of part b). Where information and services are provided to both consumers and physicians, the method can further include providing means for consumers and physicians to communicate with one another, online, about health or fitness-related issues of specific concern to the consumers.

In other preferred embodiments, consumers are given the opportunity to order, online, health or fitness-related products and services; and consumers are provided with personal web sites in which they can store information on attainment of coaching goals, generally accessible information, and specifically-provided information.

In other preferred embodiments, individualized information is provided to consumers in the form of personalized newsletters transmitted periodically online.

The invention makes available to consumers and healthcare and fitness professionals—a combination of free content and fee-based services. The free content attracts a large subscriber base (and supports revenue-generating advertising), while the fee-based services supply profits to ensure economic viability.

In another, related aspect, the invention features a method for providing personalized, health and fitness-related services to multiple subscribing consumers online; the method involves establishing for each consumer a personal web site, and providing for each consumer the ability to employ the personal web site to perform two or more, preferably three or four, and most preferably all five of the following functions: 1) recording and storing retrievable information pertaining to the consumer's personal, online coaching sessions, including personal health or fitness-related goals and attainment of such goals, 2) storing, in retrievable form, non-personalized information on health or fitness-related issues to which all subscribing consumers have access, 3) storing, in retrievable form, personal (to that subscriber) information on health or fitness-related issues, 4) storing, in retrievable form, information provided by expert consultations made available to online subscribers, and 5) storing, in retrievable form, information on personalized plans made available to online subscribers.

In yet another, related aspect, the invention features a method providing health-related information and services to two multiple people online, by performing two or more steps of a) and two or more steps b), as follows: a)—i) providing, to consumers who request it online, real-time personalized, fee-based coaching on health or fitness-related issues specifically of concern to each of said consumers; iii) periodically providing, to a plurality of consumers, online, health or fitness-related information specifically pertinent to a health or fitness issue of each said consumer or a relative of said consumer; iii) providing, to a plurality of healthcare or fitness professionals, access to information specifically pertinent to a specialty of each of said healthcare or fitness professionals; iv) providing, to consumers who request it, referrals to experts for consultation on a health or fitness-related issue of specific concern to each of said consumers; v) providing, to consumers who request them, online, personalized plans for addressing health or fitness-related issues of specific concern to each of said consumers; vi) providing, to consumers who request it, access to experts for consultation on health or fitness-related issued of specific concern to each of said consumers; b)—i) providing, to a plurality of consumers, online access to non-personalized information pertaining to health and fitness-related issues; ii) providing, to multiple consumers and/or health or fitness professionals, the option to accept opt-in advertising; iii) providing, to a plurality of healthcare or fitness professionals, online, access to non-personalized information relating to health or fitness-related issues.

In preferred embodiments of this aspect of the invention, the method includes steps a) (ii), a) (iii), b) (i), and b) (iii); more preferably the method also includes step a) (i).

Other features and advantages of the invention will be apparent from the following detailed description, and from the claims.

### DETAILED DESCRIPTION

Generally, information and services provided according to the invention fall into two classes: those provided for free to all subscribers, and those provided for a fee to a subset of subscribers who request them.

Free, universally accessible services include: 1) access by both consumers and healthcare and fitness professionals to non-personalized information pertaining to health and fitness-related issues; the information in this category that is provided to consumers can be different from that provided to healthcare and fitness professionals, although even where this is so, there will frequently be some overlap; 2) a personal web site for each subscribing consumer, and healthcare and fitness professional, in which can be stored health and fitness-related information selected for storage by the consumer or healthcare or fitness professional, both from the information provided for free, and from the fee-based information; the personal web sites can, in addition, be used by healthcare and fitness professionals to receive information from and transmit information to their patients and clients; 3) an email address for every subscribing consumer and healthcare and fitness professional; 4) a referral service in which consumers can locate experts, either among the subscribing healthcare and fitness professionals or among other experts listed in a directory; 5) a listing of experts whom the consumers can contact and ask questions of, online or offline, for a fee, generally based on the minutes during which expert consultation occurs; 6) the option to opt-in to advertising on their personal web sites and the company's sites; fees for coaching and other services can be reduced for consumers who opt for opt-in advertising (which, in some cases is tailored to consumers based on their particular health-related concerns, rendering such advertising of greater interest to these consumers).

Fee-based services include: 1) access by both subscribing consumers, and healthcare and fitness professionals to personalized information and a personal Web site pertaining to health and fitness-related issues, tailored to the particular categories of information specified by the consumer, and healthcare or fitness professional; 2) access by subscribing consumers to interactive, personalized programs, possibly combined with private email access to experts, bulletin boards, and chat rooms; 3) access by subscribing consumers to experts for telephone, online, email, or in-person consultations; 4) access by subscribing consumers to online personal coaches for private, online, one-on-one coaching sessions; 5) sales of other products and services to subscribing consumers, and healthcare and fitness professionals.

Each of the elements in the comprehensive system of the invention is known (although not in combination with the others), and therefore does not require further description, with the exception of the provision, to each subscriber who wants it, of a personal web site that allows the subscriber (sometimes referred to as a consumer) to store and retrieve personalized and non-personalized information on topics of choice (as described above), and the online personal coaching feature. This coaching system is demonstrated on the Web at www.wellcoaches.com, and is described in co-pending U.S. Ser. No. 09/628,607, of which this application is a continuation-in-part, and which is reproduced, in part, below.

Online Personal Coaching

Each client is assigned a personal coach who interacts with the client, via the Internet, to improve the health and fitness of the individual. The first step is to establish the baseline health, fitness, stress, weight, and nutrition facts for the client. This is done by having the client complete a questionnaire that inquires into the client's general health (including the presence of disease states such as diabetes and coronary artery disease), eating habits, stress levels, daily schedules, physical activity patterns, and readiness to change in each area.

The coach proposes guidelines and initial health, nutrition, fitness, weight and stress management goals based on the baseline information provided by the client in the questionnaire. The coach then works with the client online to agree the short-term and longer-term goals, and helps the client take small steps each week toward the goals.

To maintain early gains in health and fitness, and in particular to build on those gains to achieve the next level, the client must, we believe, develop a long-term relationship with her personal online coach. The coach becomes, over time, intimately familiar with her client's life habits as they evolve and change in response to coaching. Only a coach who has worked with a client over time can provide the trust-based motivation necessary to achieve lasting, progressive improvements in health and fitness. The coach knows, respects, and cares about each of her clients. She cheers her client's victories and helps her, in a positive way, understand and improve on the habits and behaviors that have stood in the way of her looking and feeling her best.

Another vital link in the motivational process that is essential for real, lasting change is the client's ability to rely on a regularly scheduled one-on-one online coaching slot with her coach. This fixed schedule achieves several important objectives.

First, a schedule eliminates the uncertainty that would ensue with random or unscheduled sessions.

Second, the scheduled sessions give the client something to look forward to: she knows that at 3 pm twice per week, for example, she will have the chance (over the Internet) to tell her coach, with whom she has developed a bond of mutual respect and caring, of her gains over the past two days. She also knows that this scheduled session provides her the opportunity to talk to her coach online about any new (or chronic) health or wellness-related problems, and find out what her coach suggests to address the problems. Immediate solutions, of course, are not always possible, and are in any event not the only dividends of coaching; the client, like any other human being, wants to be listened to by someone she knows, and who cares about her.

Finally, a fixed schedule relieves the client from a large portion of the motivational burden to keep going on the program: the client does not need to summon the will, or find that she cannot summon the will, to contact a counselor at a given time. That component of her motivation is already fixed, for the foreseeable future, and the. client is freed from struggling with that issue anew every time she thinks she might benefit from counseling. She can instead focus her efforts on maximizing the benefits of each scheduled coaching session.

Interaction via the Internet provides advantages for coaching that are not possible by other means. Individuals with concerns are often embarrassed and reserved about discussing their problems in person or by telephone. Where a client's concerns relate to personal appearance, she may be uncomfortable being looked at by a coach. Individuals will often say things online that they wouldn't say in person, or even on the telephone. The Internet mode of contact can facilitate more intimate, open, and honest discussion of difficult issues, enabling a more effective ongoing interaction with a coach.

The coaching system of the invention is applicable to any of a wide range of health-related issues. Examples are: psychological issues involving relationships (family, romantic, professional), stress and anxiety, depression, pregnancy, addiction, e.g. to alcohol or tobacco, child rearing, careers, menopause, chronic diseases such as diabetes, and caring for relatives with medical problems such as Alzheimer's disease.

The coaching system thus features a method by which a company provides interactive, Internet-based, ongoing advice and coaching to a plurality of individuals, involving: a) providing a cadre of trained coaches, all of whom interact with clients via the Internet, using as guidance a coaching manual and training provided by the company and/or its affiliates; b) at some stage in the method prior to step f), below, assigning, from the cadre of coaches, an online personal coach to each individual; c) receiving from the individual information particular to an ongoing health and fitness-related concern of the individual (e.g., weight loss or cardiac rehabilitation); d) based on the information provided in step c), devising a set of recommendations for the individual pertinent to the individual's ongoing concern; e) transmitting recommendations of step d) to the individual via the Internet; f) having transmitted to the individual's coach, via the Internet, particularized information from the individual pertaining to the ongoing concern of the individual, wherein the information includes reportage of events occurring in the life of the individual subsequent to the transmittal of the recommendations of step e); g) based on the information received by the individual's coach in step f), having the coach devise a further set of recommendations for the individual pertinent to the ongoing concern of the individual; h) transmitting the recommendations of step g) to the individual via the Internet; and i) repeating steps f-h) multiple times.

Preferably, the online interactions between the individual and the coach of steps f-h) include real-time dialogues; and the interactions occur at scheduled times. Coaching sessions occur either entirely online, or have one or more online components, including one, two, or all of “chat,” Internet telephone, Internet audio other than telephony, video, and text/illustrations sharing formats. Conventional telephone can in some instances be used in conjunction with the Internet components.

A feature that can be added to the coaching process to provide an operant conditioning component that can enhance progress in meeting client goals is to provide incentives for reaching goals. Thus, the company provides rewards, or points redeemable for rewards, for achievement of goals. For example, if a client loses ten pounds over a period of three months, consistent with goals the coach and client have set for the client, the company gives the client a reward such as a piece of fitness equipment or apparel, or points in the company's system that are redeemable for high-quality items that market research has shown clients want, including new items of clothing that accentuate improvements in appearance. These items are selected by the client from catalogues based on arrangements with apparel or other companies, or from the company's own catalogue.

Points in the reward system can be earned as well in at least two other ways: 1) clients are awarded points for agreeing to communicate (usually by the Internet), with prospective clients; this helps build the business in an effective way, with testimonials; and 2) clients are awarded points for being on time for or not missing some predetermined number of scheduled coaching appointments.

This system of rewards for achieved goals is in an important sense the antithesis of incentive systems of other health-related programs. For example, in the Jenny Craig weight-loss system, it is the client, not the company, that is rewarded for the reaching of client goals; the client pays the company one dollar for every pound the client loses. This in effect is the opposite of operant conditioning; the benefit of weight loss is accompanied by a monetary penalty. The system of the invention, in contrast, sends the client a consistent message: reaching the client's goals is accompanied by a further benefit, awarded by the company. Thus the client has two sources of motivation for reaching her goals, and is more likely to do so.

Another optional feature that can enhance the commitment, loyalty and team spirit of the coaches is a chat room to which only the coaches, but not the clients or the general public, have access. The coaches' chat room can serve as an after-hours retreat for the coaches, and provide them an opportunity to compare notes on client issues and the coaching process.

In addition, the program can include a chat room to which only the clients, but not the coaches or the general public, have access. This site provides the clients with the chance to support each other in their struggles to overcome problems they have in common. In addition, relationships, including romantic ones, can be fostered through such a site, and indeed can be formalized through a web site-specific introduction program.

Both the clients' chat room and the coaches' chat room may feature, from time to time, guest “speakers,” who are authorities on relevant topics.

Some clients will be hesitant to sign up for the coaching program because they do not place a high enough priority on their own health and fitness. To reach such clients, the company may offer gift certificates to individuals who purchase the coaching services for a spouse, child, family member, friend, or colleague.

An objective of the programs of the invention is to provide practical, personalized plans and ongoing, Internet-based coaching to help people improve their lives. The system helps clients lose weight, increase physical activity, reduce stress, improve their nutrition, and reduce their health risks.

The coaching program draws on a large and comprehensive database of old and new approaches to improving health, fitness, and well-being. The database is continually updated, with the aid of expert advisors. The database is used primarily for the development of a coach manual and coach certification program, which is continuously updated. Each coach has access to the manual, which is used both to train and test the coach prior to her beginning her coaching of clients, and as a reference for providing online recommendations to clients. The manual is a key component of the system, as it ensures uniformity of philosophy and substance from coach to coach in advising clients.

Coaches are recruited from a range of backgrounds. Preferably, they are college-educated, and have educational and/or work experience in fitness, health, nutrition, education, nursing, counseling, physical therapy, exercise physiology, or social work. Coaches are chosen as well for their natural coaching ability, empathy, and integrity.

On each client's web site there is maintained an electronic (i.e., digital) record of the goals that the coach and client set for the client, and the history of the client's meeting of those goals. In one preferred embodiment, a coaching session that takes advantage of the stored goals proceeds as follows.

The client and coach log on at the predetermined time, and recording (both audio taping and digital recording of text) of the session begins. A running clock appears on the screens of both client and coach. At the start of the session, both the client and the coach are viewing the same on-screen text listing the client's goals from the previous week or other period during which they had agreed on those goals; they use the present session, at least in part, to discuss whether the goals have been met, and strategies for meeting those that are still unmet. For example, the client may have had, as the previous week's goals, the following: 1. substitute, for night-time sweet snack, a low-calorie snack; 2. determine schedule of locally-offered yoga and step classes; 3. walk instead of drive to the train station five days in a row.

As the session begins, the coach's talking head appears on the client's screen; the coach and client talk via Internet telephony or telephone about the previous week's goals, the challenges in meeting some of them, goals for the next time period, and other remaining issues. Although the coach's face is visible to the client, the client can choose to be seen or not seen by the coach, allowing the client to maintain privacy and modesty (he can be sitting in the bathtub if he likes).

During or following the recorded session, one or both of client and coach type goals for the next time period (a week, bi-week, or month). This new goal text, along with the text of the previous goals, is stored in the client's electronic file; the file can be called up on the client's screen at any time between coaching sessions. This file allows the client to track her progress over time, and encourages the client to view her personal growth project in a manner similar to the way she would view a long-term assignment at work, i.e., tracking goals met and not met is in some respects an exercise in project management. The file acts not just as a long-term motivating force, but also as a reality check: the client can instantly check whether, six months ago, she really did weigh more than she does now.

As is discussed above, the above-described coaching system can be combined with any number of other free and fee-based features of the system of the invention.

What is claimed is:

1. A method for providing health-related information and services to multiple people online, said method comprising the steps of:
a) providing, to consumers who request it, online, real-time, personalized, fee-based coaching on health or fitness-related issues specifically of concern to each of said consumers; and
b) performing one or more additional steps selected from the group consisting of:
i) periodically providing, to a plurality of consumers, online, health or fitness-related information specifically pertinent to a health or fitness issue of each said consumer or a relative of said consumer;
ii) providing, to a plurality of healthcare or fitness professionals, online, access to non-personalized information relating to health or fitness-related issues;
iii) providing, to a plurality of healthcare or fitness professionals, access to information specifically pertinent to a specialty of each of said healthcare or fitness professionals;
iv) providing, to consumers who request it, referrals to experts for consultation on a health or fitness-related issue of specific concern to each of said consumers;
v) providing, to consumers who request them, online, personalized plans for addressing health or fitness-related issues of specific concern to each of said consumers;
vi) providing, to consumers who request it, access to experts for consultation on health or fitness-related issues of specific concern to each of said consumers;
vii) providing, to a plurality of consumers, online access to non-personalized information pertaining to health and fitness-related issues; and
viii) providing, to multiple consumers and/or health or fitness professionals, the option to accept opt-in advertising.

2. The method of claim 1, wherein said method includes two or more of steps i) through viii).

3. The method of claim 2, wherein said method includes three or more of steps i) through viii).

4. The method of claim 3, wherein said method includes four or more of steps i) through viii).

5. The method of claim 4, wherein said method includes five or more of steps i) through viii).

6. The method of claim 5, wherein said method includes six or more of steps i) through viii).

7. The method of claim 6, wherein said method includes seven or more steps i) through viii).

8. The method of claim 7, wherein said method includes all of steps i) through viii).

9. The method of claim 1, wherein said method includes step vii), which is provided to said consumers without charge.

10. The method of claim 1, wherein said method includes step ii), which is provided to said healthcare or fitness professionals without charge.

11. The method of claim 1, wherein said method includes step i), which is provided to said consumers for a fee.

12. The method of claim 10, wherein said method further includes step iii), which is provided to said healthcare or fitness professionals for a fee.

13. The method of claim 11, wherein said method further includes step v), which is provided to said consumers for a fee.

14. The method of claim 11, wherein the information of step i) is provided in the form of a personalized newsletter transmitted periodically to each said consumer online.

15. The method of claim 1, further comprising the step of c) providing the opportunity for the consumers of step a) to order, online, health or fitness-related products or services.

16. The method of claim 10, wherein said method further comprises step ii) or step iii), and wherein said method further comprises the step of c) providing means for at least some of said consumers and at least some of said healthcare or fitness professionals to communicate with one another, online, about health-related issues of specific concern to said consumers.

17. The method of claim 1, wherein, in connection with the coaching of step a), each of the consumers being coached is provided with a personal web site wherein information on the consumer's attainment of goals of said coaching are stored, periodically updated, and made accessible to said consumer.

18. The method of claim 1, wherein the fee for said coaching is reduced for each consumer who agrees to receive, online, opt-in advertising.

19. The method of claim 14, wherein the fee for said newsletter is reduced for each consumer who agrees to receive, online, opt-in advertising.

20. The method of claim 17, wherein said advertising is targeted to each said consumer based on health or fitness-related issues of concern to said consumer.

21. The method of claim 10, wherein said advertising is targeted to each said consumer based on health or fitness-related issues of concern to said consumer.

22. The method of claim 17, wherein said method further comprises steps i) and vii), and wherein each said consumer can use said personal web site to store and access selected information from steps i) and vii).

23. The method of claim 12, wherein said fee is reduced for said healthcare or fitness professionals who agree to receive, online, opt-in advertising.

24. A method for providing a personalized, health or fitness-related service to multiple subscribing consumers online, said method comprising the steps of:
a) establishing, for each consumer, a personal web site, and
b) providing, for each consumer, the means to employ said personal web site for one or more of the functions selected from the group consisting of:
1) recording and storing retrievable information pertaining to the consumer's personal, online coaching sessions, including personal health or fitness-related goals and attainment of said goals,
2) storing, in retrievable form, non-personalized information on health or fitness-related issues to which all said subscribing consumers have access,
3) storing, in retrievable form, personalized information on health or fitness-related issues,
4) storing, in retrievable form, information provided by expert consultations, and
5) storing, in retrievable form, information in personalized plans provided to subscribers.

25. The method of claim 24, wherein each consumer is provided the means to employ said personal website for two or more said functions.

26. The method of claim 25, wherein each consumer is provided the means to employ said personal website for three or more said functions.

27. The method of claim 26, wherein each consumer is provided the means to employ said personal website for four or more said functions.

28. The method of claim 27, wherein each consumer is provided the means to employ said personal website for all five said functions.

29. A method for providing health-related information and services to multiple people online, said method comprising performing two or more steps of a) and two or more steps of b), below:
a)
a. providing, to consumers who request it online, real-time personalized, fee-based coaching on health or fitness-related issues specifically of concern to each of said consumers;
b. periodically providing, to a plurality of consumers, online, health or fitness-related information specifically pertinent to a health or fitness issue of each said consumer or a relative of said consumer;
c. providing, to a plurality of healthcare or fitness professionals, access to information specifically pertinent to a specialty of each of said healthcare or fitness professionals;
d. providing, to consumers who request it, referrals to experts for consultation on a health or fitness-related issue of specific concern to each of said consumers;
e. providing, to consumers who request them, online, personalized plans for addressing health or fitness-related issues of specific concern to each of said consumers;
f. providing, to consumers who request it, access to experts for consultation on health or fitness-related issue of specific concern to each of said consumers;
b)
i) providing, to a plurality of consumers, online access to non-personalized information pertaining to health and fitness-related issues;
ii) providing, to multiple consumers and/or health or fitness professionals, the option to accept opt-in advertising;
ii) providing, to a plurality of healthcare or fitness professionals, online, access to non-personalized information relating to health or fitness-related issues.

30. The method of claim 29 wherein said method includes steps a) (ii), a) iii), b) (i), and b) (iii).

31. The method of claim 30, wherein said method further includes step a) (i).
